(19) United States
(12) Patent Application Publication
(10) Pub. No.: US 2018/0166202 A1
(43) Pub. Date: Jun. 14, 2018

(54) CERAMIC ELECTRONIC COMPONENT AND MANUFACTURING METHOD THEREOF

(71) Applicant: Murata Manufacturing Co., Ltd., Kyoto-fu (JP)

(72) Inventors: Takuya ISHIDA, Nagaokakyo-shi (JP); Yoshifumi MAKI, Nagaokakyo-shi (JP); Shinya HIRAI, Nagaokakyo-shi (JP)

(73) Assignee: Murata Manufacturing Co., Ltd., Kyoto-fu (JP)

(21) Appl. No.: 15/836,494

(22) Filed: Dec. 8, 2017

(30) Foreign Application Priority Data
Dec. 14, 2016 (JP) 2016-242002

(51) Int. Cl. H01F 27/24; H01F 27/29; H01F 41/02

(52) U.S. Cl. CPC H01F 27/24; H01F 41/02; H01F 27/29

(57) ABSTRACT

A ceramic electronic component and manufacturing method are capable of easily forming a plating electrode on any portion of a surface of a ceramic body. The ceramic electronic component includes a ceramic body containing a metal oxide, a modified layer formed on a surface layer portion of the ceramic body, on which a portion of the metal oxide is melted and solidified, and an electrode comprising a plated metal formed on the modified layer. In the modified layer, at least one of metal elements constituting the metal oxide is segregated. Plated metal is likely to be deposited due to segregation of the metal elements.

### CROSS-REFERENCE TO RELATED APPLICATION

This application claims benefit of priority to Japanese Patent Application No. 2016-242002, filed Dec. 14, 2016, the entire content of which is incorporated herein by reference.

### BACKGROUND

### Technical Field

The present disclosure relates to a ceramic electronic component, and particularly to a ceramic electronic component in which a plating electrode is formed on the surface of a ceramic body and a method for manufacturing the same.

### Description of the Related Art

Conventionally, as a method of forming an external electrode of an electronic component, it is general to apply an electrode paste to both end surfaces of a ceramic body, subsequently bake or thermally cure the electrode paste to form a base electrode, and then form a plating electrode on the base electrode by plating treatment.

For the application of the electrode paste, a method of immersing an end of the electronic component in a paste film formed with a predetermined thickness or a method using a transfer by a roller or the like is used. In these techniques, there is a problem that the thickness of the electrode is increased due to the application of the electrode paste, and the external dimension is increased correspondingly.

Instead of such an electrode forming method using an electrode paste, suggested is a method of exposing a plurality of ends of internal electrodes to be close to the end surface of a ceramic body, while exposing a dummy terminal called an anchor tab to be close to the end surface similarly to the ends of the internal electrodes, and performing electroless plating on the ceramic body, thereby further plating a plated metal with the ends of the internal electrodes and the anchor tab as a core to form an external electrode (Japanese Patent Application Laid-Open No. 2004-40084). With this method, an external electrode can be formed only by plating treatment.

In this method, however, as the core for depositing the plating, it is necessary to expose the ends of the plurality of internal electrodes and the anchor tab close to the end surface of the ceramic body, and thus the manufacturing process becomes complicated, resulting in an increase in cost. In addition, since the external electrodes can be formed only on the surface where the ends of the internal electrodes are exposed, there is a problem that the formation site of the external electrode is restricted.

### SUMMARY

The present disclosure provides a ceramic electronic component in which a plating electrode is formed on an arbitrary site on the surface of a ceramic body, and a manufacturing method thereof. A first aspect of the present disclosure provides a ceramic electronic component including a ceramic body containing a metal oxide, a modified layer formed on a surface layer portion of the ceramic body, on which a portion of the metal oxide is melted and solidified, and an electrode comprising a plated metal formed on the modified layer, at least one of metal elements constituting the metal oxide being segregated in the modified layer.

The present inventors have found that when a modified layer is formed by locally melting and solidifying a surface layer portion of a ceramic body containing a metal oxide, at least one of metal elements constituting the metal oxide is segregated in the modified layer. The segregation of the metal element improves plating deposition properties. Therefore, when this ceramic body is plated, a plated metal is deposited on the modified layer, and the plated metal is rapidly further plated using the deposited plated metal as a core, so that a plating electrode can be formed. Therefore, complicated steps such as conventional application and baking of a conductive paste are not required, and the step of forming an electrode is simplified. Furthermore, it is not necessary to expose the plurality of internal electrodes and the anchor tab to be close to the end surface of the ceramic body as in Japanese Patent Application Laid-Open No. 2004-40084. Therefore, there is no restriction on the formation site of the electrode, and the manufacturing process is simplified, resulting in cost reduction.

In the present disclosure, “an electrode comprising a plated metal” is not limited to an external electrode, and may be any electrode. For example, a pad electrode, a land electrode, a coil electrode or a circuit pattern electrode may be used. Further, the ceramic electronic component is not limited to a chip component, but may be a composite component such as a circuit module, a circuit substrate, or a multilayer substrate. Also, the “modified layer” of the present disclosure is not required to be continuous in a layer form, and a plurality of portions may be independent.

In the case where the ceramic body is ferrite containing Cu, Cu may be segregated in the upper layer portion of the modified layer. In the case where ferrite is an oxide mainly composed of Fe₂O₃ and an oxide of Cu is contained therein, and when the surface layer portion of this ferrite is modified by melting and solidification, a portion of the Cu oxide is reduced to be segregated in the upper layer portion of the modified layer. Since Cu has better conductivity or has a higher potential than Fe and other metals, a plated metal is likely to be deposited on the modified layer.

In the case of ferrite containing Cu, the modified layer may have a structure having a segregated layer of Cu in the upper layer portion and having an unsegregated layer in which Cu is not segregated in the lower layer portion. When Cu is segregated in the upper layer portion of the modified layer as described above, the Cu component relatively decreases in the lower layer portion of the modified layer, and thus an unsegregated layer of Cu is formed in that region. The unsegregated layer of Cu does not mean that the amount of the Cu component is zero, but a layer in which segregation of Cu does not occur. In this case, the plating deposition properties of the upper layer portion of the modified layer are improved.

When the ceramic body is ferrite containing Cu, the segregation form of Cu changes depending on the degree of modification. For example, when the degree of modification is relatively low, Cu is likely to be segregated in a stripe or pillar shape. In this case, plating of the modified layer is likely to be deposited more than before segregation. Further, as the modification progresses, the segregation form of Cu changes to a mesh shape. In this case, the plating deposition properties of the modified layer are further improved.

When the ceramic body is ferrite containing Cu, Zn and Ni, Zn and Ni may be present in the modified layer so as to avoid segregation of Cu. Cu is segregated in a stripe or mesh shape as described above, whereas Zn and Ni are not segregated in a stripe or mesh shape, but are present so as to avoid the segregation portion of Cu. Therefore, in the case of the ferrite containing Cu, Zn and Ni, there is a possibility that, among the metal elements, the Cu portion is present separately from the Zn and Ni portions.

A second aspect of the present disclosure provides a ceramic electronic component including a ceramic body containing a metal oxide, a modified layer formed on a portion of a surface layer portion of the ceramic body, on which the metal oxide is melted and solidified, and an electrode comprising a plated metal formed on the modified layer. At least one of metal elements constitute the metal oxide being reduced in the modified layer, and the plating deposition properties of the modified layer being higher than those of an unmodified layer.

For example, in the case of ferrite containing no Cu or containing only a trace amount of Cu, such as a Ni—Zn ferrite and a Mn—Zn ferrite, and when the surface layer portion is locally melted and solidified to form a modified layer, Cu is not segregated in the modified layer, but at least a portion of other metal elements is reduced to form a layer. Since the modified layer is a layer having better plating deposition properties than that of the unmodified layer, a plating electrode can be easily formed on the modified layer by plating treatment.

The thickness of the modified layer is preferably 1 μm or more. The thickness of the modified layer varies depending on the degree of melting and solidification. The thickness of the modified layer is correlated with the electrical resistance, and affects plating deposition properties. When the thickness of the modified layer is less than 1 μm, the electrical resistance of the modified layer is hardly reduced, and the plating is not deposited or deposited only to a very small extent. On the other hand, when the thickness of the modified layer is 1 μm or more, the electrical resistance is reduced, and the plating can be effectively deposited.

One aspect of the present disclosure provides a method for manufacturing a ceramic electronic component including the steps of preparing a ceramic body containing a metal oxide, melting and solidifying the metal oxide on a portion of a surface layer portion of the ceramic body to form a modified layer in which at least one of the metal elements constituting the metal oxide is segregated, and forming an electrode on the modified layer by plating treatment. By this method, the ceramic electronic component of the present disclosure can be easily manufactured.

Another aspect of the present disclosure provides a method for manufacturing a ceramic electronic component including the steps of preparing a ceramic body containing a metal oxide, melting and solidifying the metal oxide on a portion of a surface layer portion of the ceramic body to form a modified layer in which at least one of metal elements constituting the metal oxide is reduced, the plating deposition properties of the modified layer being higher than those of an unmodified layer, and forming an electrode on the modified layer by plating treatment.

The step of forming the modified layer may be performed by laser irradiation, electron beam irradiation, or local heating by an image furnace. In these methods, only a specific site of the ceramic body can be locally heated without using a mask or the like prepared in advance, and therefore, the productivity is very high. Since local heating heats and modifies only the surface layer portion of the ceramic body, there is no substantial effect on the electrical characteristics as the electronic component. In particular, laser irradiation is advantageous in that the apparatus can be constructed relatively small, and the irradiation position of laser can be quickly changed. A known laser such as YAG laser or YVO₄ laser can be used for the laser.

As a method of plating treatment in the present disclosure, either electroplating or electroless plating can be used. In the case of electroplating, there is an advantage that it is easy to control the film thickness.

One of the features of the method of the present disclosure is that electrodes can be easily formed at any sites. For example, when modified layers are formed only on both longitudinal end surfaces of a ceramic body and on one surface (for example, the bottom surface) adjacent to both end surfaces, it becomes possible to form an external electrode having an L-shaped cross section. That is, it is also possible to form external electrodes only on both end surfaces and the bottom surface, and not to form electrodes on the upper surface and both side surfaces in the width direction. The advantage of forming the L-shaped external electrode is that the mounting area can be reduced while maintaining the fixing strength, the present ceramic electronic component can be mounted at a high density, and electrical interference with other adjacent electronic components can be suppressed.

As described above, according to the present disclosure, a modified layer in which a portion of a metal oxide is melted and solidified is formed on a surface layer portion of a ceramic body, and the modified layer is constituted so that at least one of metal elements constituting the metal oxide is segregated. Thus, it is possible to deposit a plated metal on the modified layer. In the present disclosure, it is possible to easily form a plating electrode without requiring a complicated step. Furthermore, there is no restriction on the formation site of the electrode as long as it is a site where the modified layer can be formed.

### BRIEF DESCRIPTION OF THE DRAWINGS

FIG. 1 is a perspective view of a wire-wound inductor as a first embodiment of the ceramic electronic component according to the present disclosure;

FIG. 2 is a partial sectional view of the wire-wound inductor shown in FIG. 1;

FIGS. 3A to 3C are views showing some examples of a method of irradiating a core with a laser;

FIGS. 4A to 4D are sectional views showing an example of a step of forming a modified portion and a plating electrode;

FIGS. 5A to 5D are sectional views showing other examples of a step of forming a modified portion and a plating electrode;

FIG. 6 is a view showing an example of a sectional structure of a modified layer;

FIGS. 7A to 7C are diagrams schematically showing a structure of a modified layer and a plating layer in a Ni—Cu—Zn ferrite, a Ni—Zn ferrite, and a Mn—Zn ferrite;

FIGS. 8A and 8B are diagrams schematically showing a segregation state of a modified layer in a Ni—Cu—Zn ferrite;

FIG. 9 shows sTEM images and EDX images before and after laser irradiation in Samples 1 to 4;

FIG. 10 shows sTEM images and EDX images after laser irradiation in Samples 5 and 6;

FIG. 11 is a diagram showing the relationship between the thickness of a modified layer and the resistivity;

FIG. 12 is a diagram showing the relationship between the thickness of a Cu segregated layer and the resistivity;

FIGS. 13A and 13B show EDX quantitative analysis results of metal elements before and after laser irradiation on a Ni—Cu—Zn ferrite;

FIG. 14 is a perspective view of a common mode choke coil of two lines (four terminals) as a second embodiment of the present disclosure;

FIG. 15 is a perspective view of a coil component of three lines (six terminals) as a third embodiment of the present disclosure;

FIG. 16 is a perspective view of a coil component of four lines (eight terminals) as a fourth embodiment of the present disclosure;

FIG. 17 is a perspective view showing an example of a multilayer inductor as a fifth embodiment of the present disclosure; and

FIGS. 18A and 18B are perspective views showing other examples of multilayer inductors as a sixth embodiment and a seventh embodiment of the present disclosure.

### DETAILED DESCRIPTION

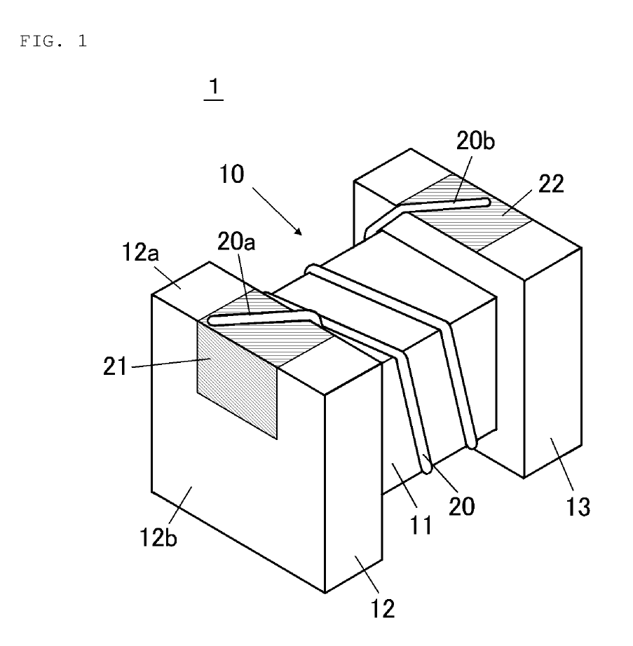

FIG. 1 shows a wire-wound inductor 1 as a first embodiment of the ceramic electronic component according to the present disclosure. In FIG. 1, the bottom surface of the inductor 1 is shown to face upward. The inductor 1 includes a winding core portion 11, a core (ceramic body) 10 having flange portions 12 and 13 formed at both ends of the winding core portion 11, a wire 20 wound around the winding core portion 11, and external electrodes 21 and 22 to which both ends 20a and 20b of the wire 20 are electrically connected. It should be noted that the drawings including FIG. 1 are all schematic, and their dimensions, scales of aspect ratios, etc. may differ from actual products.

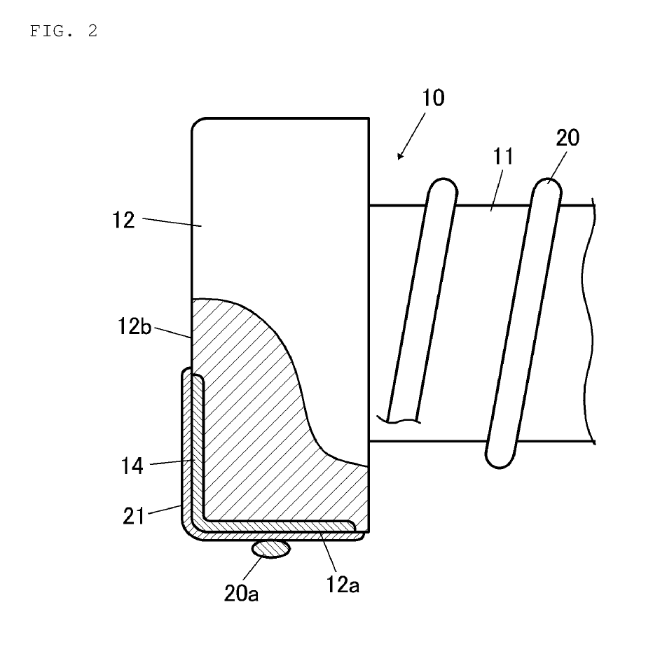

The core 10 is made of, for example, a sintered ceramic material containing a metal oxide, such as a Ni—Cu—Zn ferrite, a Ni—Zn ferrite or a Mn—Zn ferrite. FIG. 2 is an enlarged sectional view of a portion of the wire-wound inductor 1 shown in FIG. 1, and is a sectional view showing the vicinity of one flange portion 12 of the core 10 in an enlarged manner. Although illustration and description are omitted, the vicinity of the other flange portion 13 of the core 10 also has the same structure as in FIG. 2. As shown in FIG. 2, on the surface layer portion of the flange portion 12, a modified layer 14 is provided from a bottom surface 12a to a side surface 12b. Here, the bottom surface 12a is a mounting surface opposed to a circuit substrate when the inductor 1 is surface-mounted on the circuit substrate, and the side surface 12b is an outer surface adjacent to the bottom surface 12a and substantially perpendicular to the bottom surface 12a. The modified layer 14 is obtained by melting and solidifying a portion of the metal oxide contained in the ferrite, and an external electrode 21 comprising a plating layer is formed on the modified layer 14. Therefore, the external electrodes 21 and 22 are formed in an L-shaped cross section. In FIG. 2, the external electrode 21 is formed of one plating layer, but may be formed of a plurality of plating layers. For example, a plating layer serving as a base may be formed on the modified layer 14, and a plating layer comprising another metal may be formed thereon for the purpose of improving corrosion resistance and solder wettability. The material and the number of the plating layers constituting the external electrode 21 are arbitrary.

In this embodiment, both ends of the wire 20 are connected to the external electrodes 21 and 22 on the bottom surface sides of the flange portions 12 and 13. Both ends of the wire 20 may be connected to the external electrodes 21 and 22 on the side surface sides of the flange portions 12 and 13. The connection method is arbitrary, but it can be fixed by, for example, thermocompression bonding. As described above, when the L-shaped external electrode 21 extending to the bottom surface 12a and the side surface 12b is formed, solder adheres not only to the bottom surface 12a but also to the side surface 12b at the time of mounting on the circuit substrate to form a fillet, so that it is desirable in terms of increasing the fixing strength to the circuit substrate.

In FIG. 1, the external electrodes 21 and 22 are formed on a portion of the bottom surface and the side surface of the flange portions 12 and 13, but may be formed on the entire bottom surface and/or entire side surface. In particular, by applying the present disclosure, it is possible to selectively form the external electrodes 21 and 22 on the bottom surface and the side surface of the flange portions 12 and 13. It is because the modified layer 14 can be formed at any position of the core 10 as described later. FIG. 1 merely shows one example of the external electrodes 21 and 22, and the shape and the formation surface of the external electrodes 21 and 22 can be arbitrarily selected as long as a modified layer can be formed thereon. Therefore, the shape of the external electrodes 21 and 22 is not limited to the L-shape, and is arbitrary.

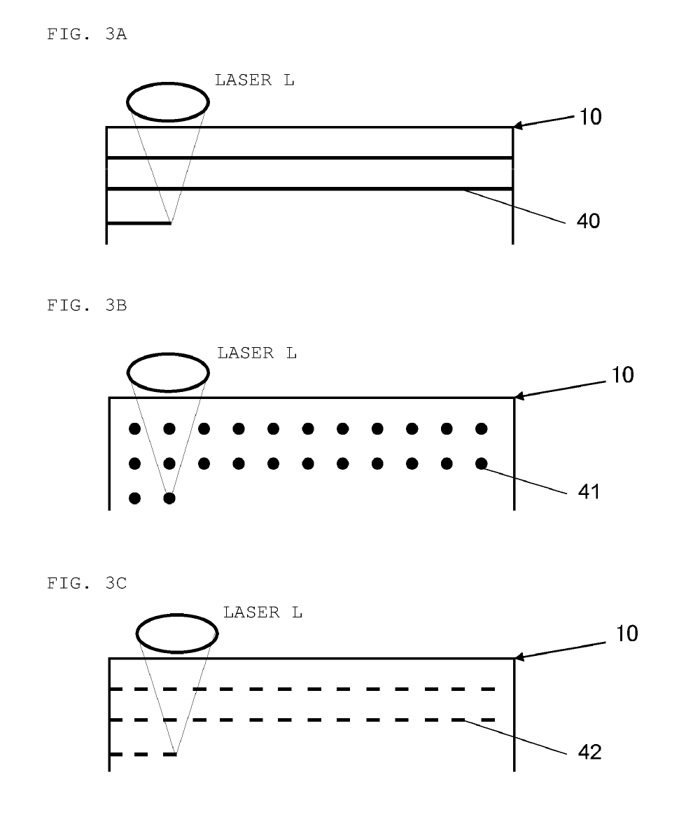

FIGS. 3A to 3C show some examples of a laser irradiation method for forming a modified layer on the surface layer portion of the core 10. FIG. 3A shows an example in which scanning is performed in the lateral direction while laser L is continuously irradiated (or an example in which the core 10 is moved in the lateral direction). The scanning direction is arbitrary, and may be a longitudinal direction, a zigzag shape, or a circular shape. By irradiation of laser L, a large number of linear laser irradiation marks 40 are formed on the surface of the core 10, and modified layers are formed under the laser irradiation marks 40. FIG. 3A shows an example in which the linear laser irradiation marks 40 are formed at intervals in the vertical direction on the paper surface, but the laser irradiation marks 40 may be densely formed so as to overlap with each other. FIG. 3B shows an example in which the laser L is irradiated in spots. In this case, a large number of point-like laser irradiation marks 41 are dispersedly formed on the surface of the core 10. FIG. 3C shows an example in which the laser L is irradiated in broken lines. In this case, a large number of broken-line laser irradiation marks 42 are dispersedly formed on the surface of the core 10. In either case, the modified layers are formed under the laser irradiation marks 41 and 42. It is desirable that the laser L is uniformly irradiated on the region where the plating electrode is to be formed.

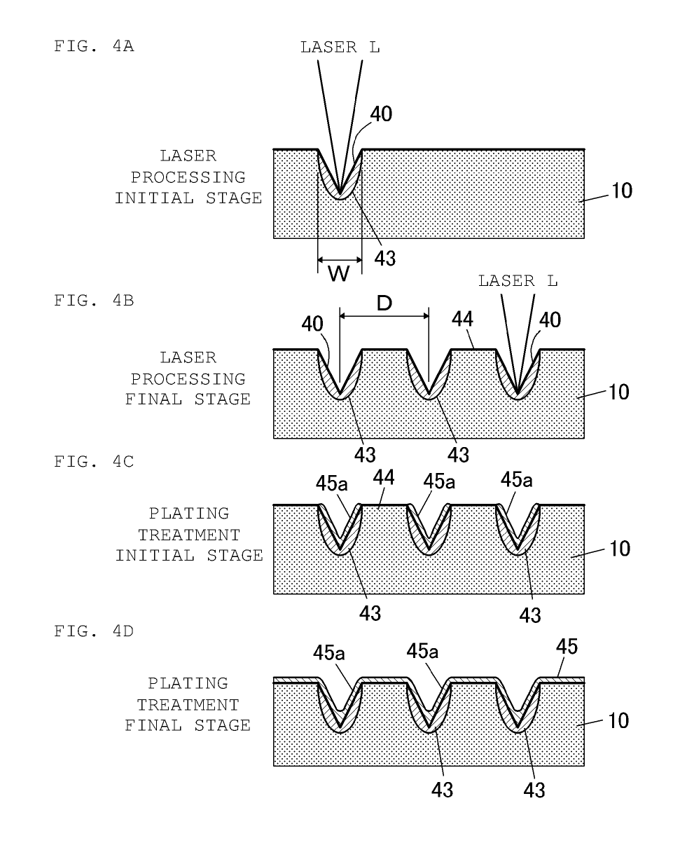

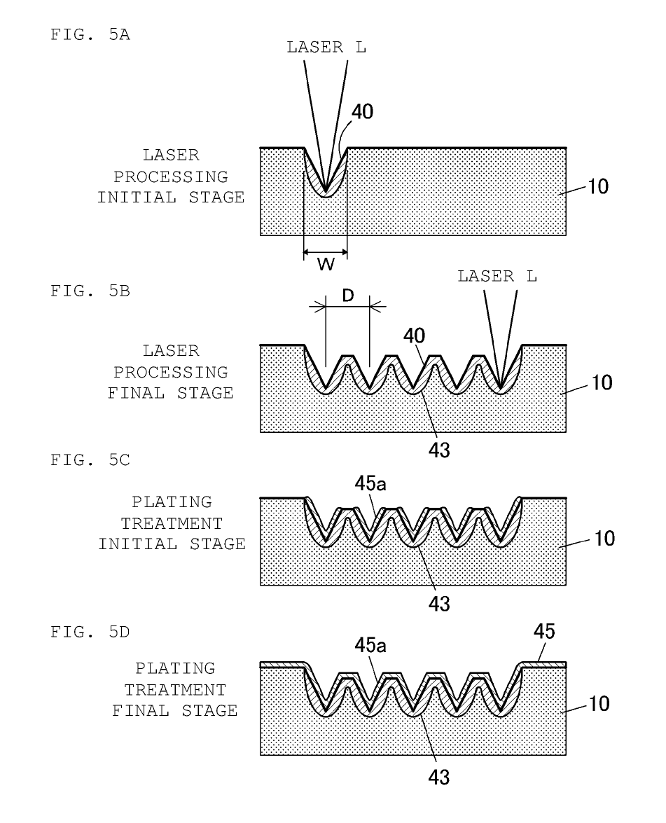

FIGS. 4A to 4D schematically show an example of a process of forming the modified layer and the plating electrode (external electrode). In particular, they show a case where the laser L is linearly irradiated on the surface of the core 10 at predetermined intervals. FIG. 4A shows a state in which the surface of the core 10 is irradiated with the laser L to form a laser irradiation mark 40 having a V-shaped or U-shaped cross section on the surface. In FIG. 4A, an example where the laser L is condensed to one point is shown, but actually, the spot irradiated with the laser L may have a certain amount of area. The laser irradiation mark 40 is a mark that the surface layer portion of the core 10 is melted and solidified by laser irradiation. Since the central portion of the spot has the highest energy, the central portion is liable to be deteriorated, and the cross section of the laser irradiation mark 40 is substantially V-shaped or substantially U-shaped. On the periphery including the inner wall surface of the laser irradiation mark 40, the ceramic material (ferrite) constituting the core 10 is changed in quality, and the modified layer 43 having a lower electrical resistance value than the ceramic material is formed. The depth and width of the modified layer 43 can be varied depending on the irradiation energy of the laser, the irradiation range, and the like.

FIG. 4B shows a state in which a plurality of laser irradiation marks 40 is formed on the surface of the core 10 at intervals D by repeating laser irradiation. In this example, the interval D between the spot centers of the laser irradiation is wider than the spreading width (or the average value of the diameters of the laser irradiation marks 40) W of the modified layer 43 (D>W), and therefore, an insulating region 44 other than the modified layer 43 is present between the laser irradiation marks 40. This insulating region 44 is a region where the ceramic material constituting the core 10 is exposed without being changed in quality. In this case, the modified layer 43 is formed in a separated state in the lateral direction on the paper surface.

FIG. 4C shows an initial state in which the core 10 having the modified portion 14 formed by laser irradiation as described above is immersed in a plating solution to perform plating. Since the current density in the modified layer 43 having a low electrical resistance value is higher than the other portion (insulating region 44), the plated metal 45a is deposited only on the surface of the modified layer 43, and has not yet deposited on the insulating region 44. That is, at this stage, a continuous plating electrode (external electrode) 45 is not formed.

FIG. 4D shows a state at the end of plating. By continuing the plating treatment, the plated metal 45a deposited on the modified layer 43 is further plated to the periphery as a core, and spreads over the insulating region 44 adjacent to the modified layer 43. By continuing the plating treatment until the adjacent plated metals 45a are connected to each other, continuous plating electrodes 45 can be formed on the surface of the core 10. Since the plating rate of the plated metal in the region other than the modified layer 43 is slower than the plating rate of the plated metal in the modified layer 43 irradiated with a laser, a plated metal can be selectively further plated on the modified layer 43, even when the plating treatment time is not strictly controlled. It is possible to control the thickness of the plating electrode 45 by controlling the plating treatment time or current.

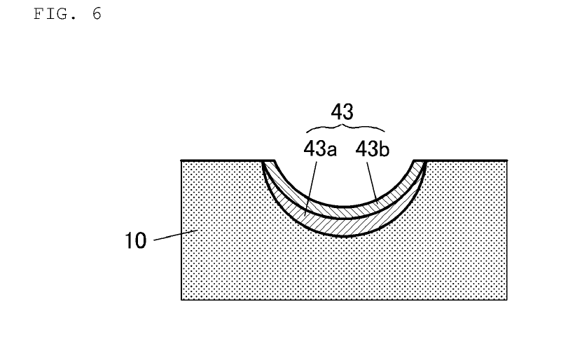

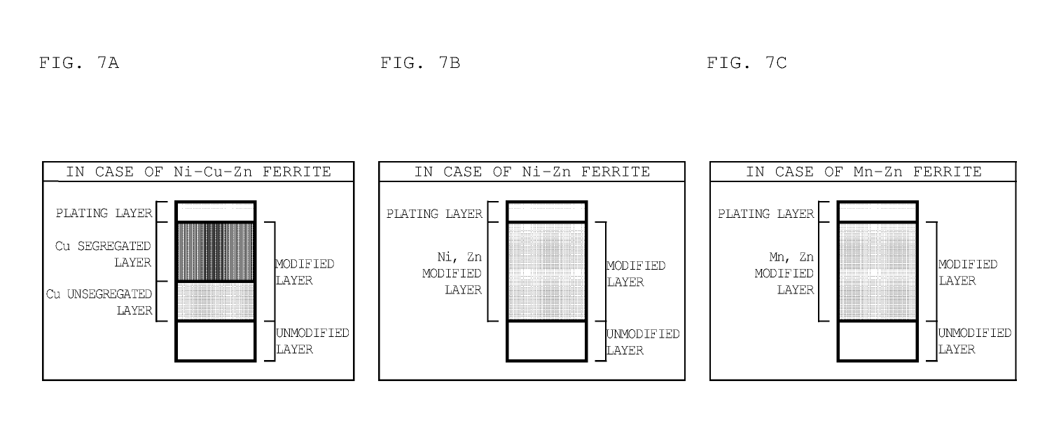

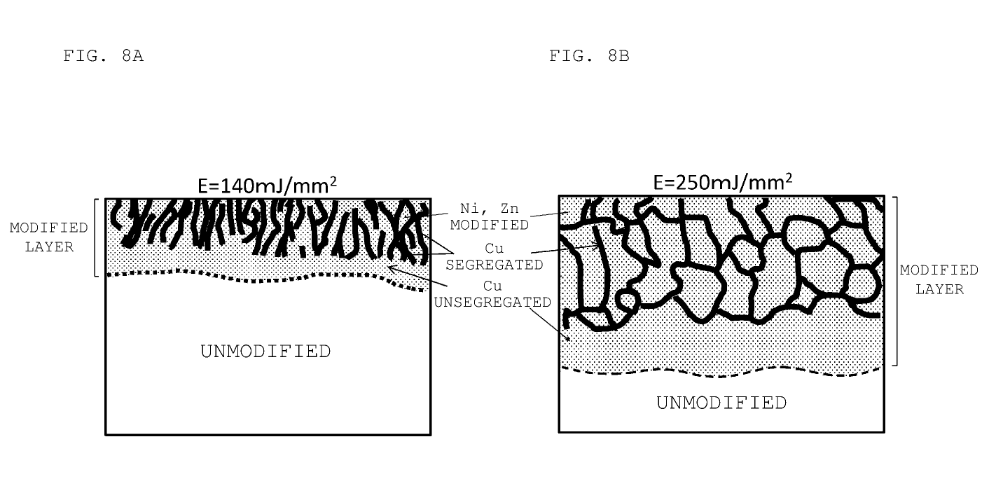

FIGS. 5A to 5D show other examples of the process of forming a plating electrode (external electrode), particularly when the surface of the core 10 is densely irradiated with the laser L. The phrase “densely irradiated” refers to that the interval D between the spot centers of the laser irradiation is equal to or narrower than the spread width W of the modified layer 43 (D≤W), and refers to the state that the modified layers 43 formed under the adjacent laser irradiation marks 40 are connected to each other (see FIG. 5B). Therefore, almost the entire area of the electrode formation region on the surface of the core 10 is covered with the modified layers 43. However, it is not necessary that all the modified layers 43 are continuous.

In this case, as shown in FIG. 5C, the plated metal 45a is deposited on the surface of the low resistance portion 43 in a short time from the start of the plating treatment, but since the plated metals 45a are substantially proximal, the adjacent plated metals 45a are quickly connected to each other. Therefore, the continuous plating electrode 45 can be formed in a shorter time than in the case of FIG. 4.

When the laser L is densely irradiated on the surface of the core 10 as shown in FIG. 5, the laser irradiation marks 40 are also densely formed, and thus the surface portion on which the modified layer 43 is formed is scraped. Since the plating electrode 45 is formed on the scraped surface portion, it is possible to make the surface of the plating electrode 45 substantially the same height as or lower than the surface portion where the modified layer 43 is not formed. Therefore, in conjunction with the thin thickness of the plating electrode 45 itself, it is possible to suppress the projection amount of the external electrode 45, thereby further reducing the size.

FIG. 6 shows an example of a sectional structure of the modified layer 43. The metal oxide contained in the ferrite is decomposed by the heat generated by laser irradiation and the metal element in the irradiated portion is reduced to form the modified layer 43. In the surface layer of the modified layer 43, a portion of the metal element is reoxidized by residual heat, and a reoxidized film 43b is formed in some cases. When the reoxidized film 43b is formed, there is also an effect that it is possible to suppress the progress of reoxidation of the reduction layer 43a in the lower layer and suppress the change with time of the reoxidized layer 43b itself. The reoxidized layer 43b is a kind of semiconductor, has a resistance value lower than that of ferrite which is an insulator, and is an extremely thin film. Thus, it does not become an obstacle to the plating treatment to be carried out later. The reoxidized film 43b is not an essential constituent, and the formation of the reoxidized film 43b can be suppressed, for example, by performing the laser irradiation not in the air atmosphere but in a vacuum or N₂ atmosphere.

Next, the structure of the modified layer when a Ni—Cu—Zn ferrite, a Ni—Zn ferrite and a Mn—Zn ferrite are used as the core 10 will be described. The modified layer can be formed by irradiating the surface of the core 10 with a laser as described above and melting and solidifying the surface layer portion of the metal oxide constituting the core 10. For example, in the case of the Ni—Cu—Zn ferrite, Fe, Ni, Cu, and Zn are contained as metal oxides, and it is considered that a portion of these metal elements is reduced and Cu is segregated in the modified layer.

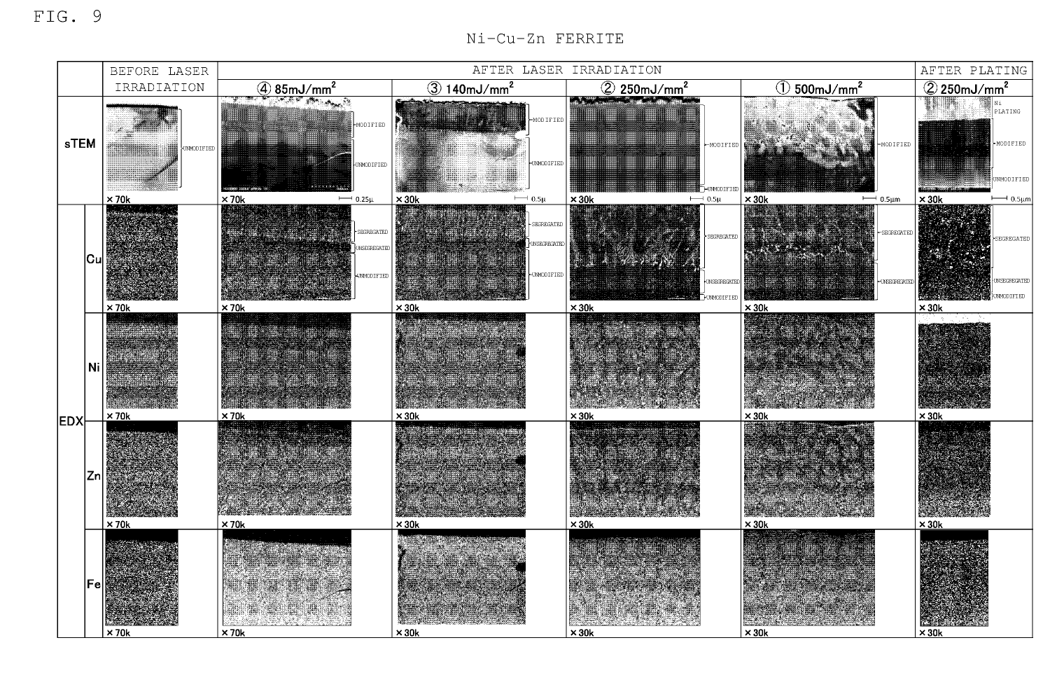

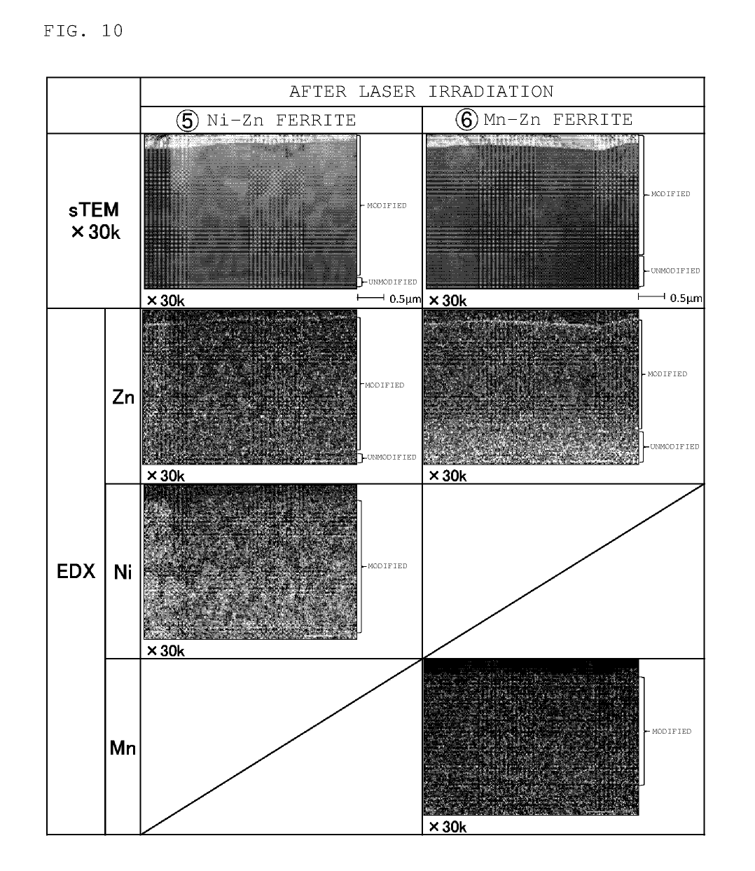

FIGS. 7A to 7C schematically show the structures of the modified layer and the plating layer in the Ni—Cu—Zn ferrite, the Ni—Zn ferrite, and the Mn—Zn ferrite. That is, in the case of the Ni—Cu—Zn ferrite, as shown in FIG. 7A, a modified layer is formed from the surface to a predetermined depth, and the lower layer is a unmodified layer, that is, a layer that remains an original metal oxide. Since the modified layer is a region where the plating deposition properties are higher than those of the unmodified layer, a plating layer is formed on the surface by plating treatment.

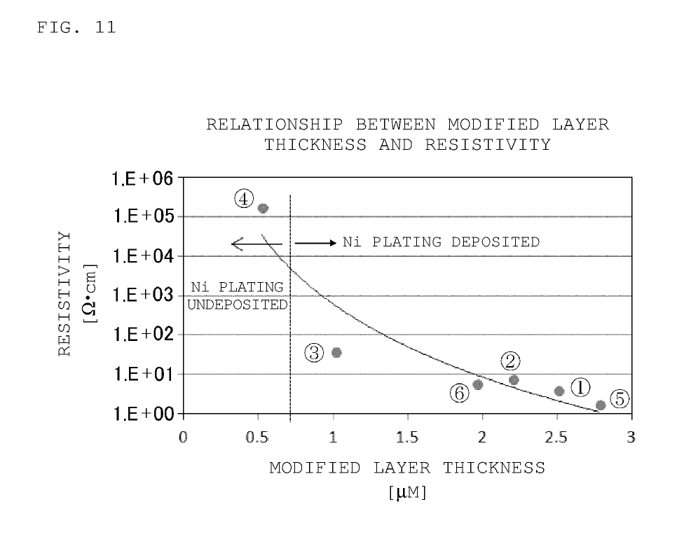

FIGS. 8A and 8B schematically show the segregation state of the modified layer in the Ni—Cu—Zn ferrite. The upper edge of FIG. 8 is the surface of ferrite. The segregation of Cu varies with the degree of modification. When a laser with relatively low energy (for example, 140 mJ/mm²) is irradiated, Cu is segregated in a stripe or pillar shape as shown in FIG. 8A. On the other hand, when a laser with high energy (for example, 250 mJ/mm²) is irradiated, Cu segregation changes to a mesh shape as shown in FIG. 8B. In FIGS. 8A and 8B, Cu segregation is planarly expressed, but it actually appears three-dimensionally. As the laser energy increases, the thickness of the modified layer increases. At this time, Zn and Ni are present so as to avoid the segregation of Cu. That is, Zn and Ni are present so as to fill the gaps of the Cu segregation in a stripe or mesh shape. Such stripe or mesh-like Cu segregation has high conductivity or high potential, and thus the plating deposition properties are improved. A unsegregated layer of Cu is generated in the lower layer portion of the Cu segregated layer, that is, between the segregated layer and the unmodified layer. This region is a region where the Cu component is relatively reduced, but Ni and Zn are present.

In the case of the Ni—Zn ferrite, as shown in FIG. 7B, a modified layer is formed from the surface to a predetermined depth, and it is similar to the Ni—Cu—Zn ferrite in that an unmodified layer is present in the lower layer. In the Ni—Zn ferrite, the amount of the Cu component is zero or a trace amount, and therefore, the modified layer is mainly composed of Ni and Zn. Also in this case, the plating deposition properties of the modified layer are higher than those of the unmodified layer, and a plating layer is formed on the surface by plating treatment.

In the case of the Mn—Zn ferrite, as shown in FIG. 7C, a modified layer is formed from the surface to a predetermined depth, and an unmodified layer is present in the lower layer. Also in this case, the plating deposition properties of the modified layer are higher than those of the unmodified layer, and thus a plating layer is formed on the surface by plating treatment.

—Experimental Results—

Next, experimental results are shown when a plurality of kinds of ferrite was used and modified layers were formed while changing laser conditions as shown in Table 1. In Table 1, the pitch is the irradiation interval of the laser beam in the adjacent rows in the case of linearly scanning a plurality of rows while continuously irradiating laser L. A Ni—Cu—Zn ferrite was used in Samples 1 to 4, a Ni—Zn ferrite was used in Sample 5, and a Mn—Zn ferrite was used in Sample 6. YVO₄ laser was used, and laser energy was varied from 85 to 500 mJ/mm².

TABLE 1

| | | \textcircled{1} | \textcircled{2} | \textcircled{3} | \textcircled{4} | \textcircled{5} | \textcircled{6} |
|---|---|---|---|---|---|---|---|
| Laser conditions | | Ni—Cu—Zn | | | | Ni—Zn | Mn—Zn |
| Output | A | 14 | 14 | 14 | 14 | 14 | 14 |
| Processing speed | mm/s | 100 | 200 | 300 | 400 | 100 | 100 |
| Qsw frequency | kHz | 150 | 150 | 40 | 20 | 150 | 150 |
| Pitch | μm | 30 | 30 | 30 | 30 | 30 | 30 |
| Energy | mJ/mm² | 500 | 250 | 140 | 85 | 500 | 500 |

Ni electroplating was performed on the modified layer prepared under the above conditions under the following conditions. Specifically, barrel plating was used.

TABLE 2

| Plating solution | Watt bath |
|---|---|
| Current [A] | 16 |
| Temperature [° C.] | 60 |
| Time [min] | 120 |

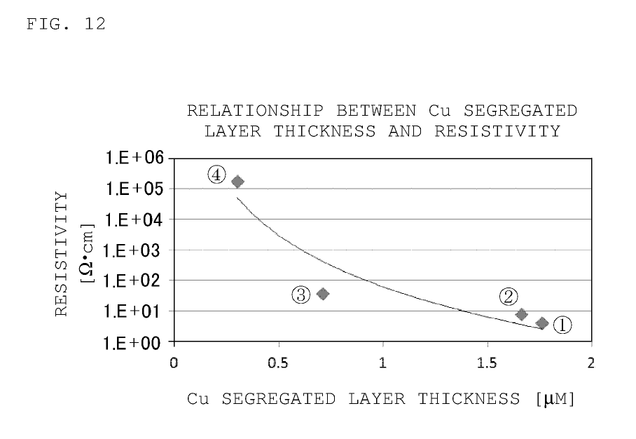

FIGS. 9 and 10 show specific examples of the respective structures of ferrite in Samples 1 to 6. FIG. 9 shows sTEM images and EDX images showing the segregation state of each metal element before and after laser irradiation in Samples 1 to 4. FIG. 10 shows sTEM images and EDX images after laser irradiation in Samples 5 and 6. FIG. 9 also shows a sTEM image and EDX images after plating in Sample 2.

As can be seen from FIG. 9, in Sample 4 (energy: 85 mJ/mm²), only a very shallow region is modified, and segregation does not progress. On the other hand, in Samples 1 to 3 (energy: 140 to 500 mJ/mm²), Cu is modified with a thickness of 1 μm or more, and clear Cu segregation in a strip or mesh shape can be confirmed. In addition, it can be seen that Ni and Zn are present so as to avoid Cu segregation.

On the other hand, as shown in FIG. 10, Zn and Ni are modified in Sample 5, and Zn and Mn are modified in Sample 6. However, it can be seen that the modified Zn and Ni, Zn and Mn are present in a dispersed state in the thickness direction, rather than stripe or mesh-like Cu segregation.

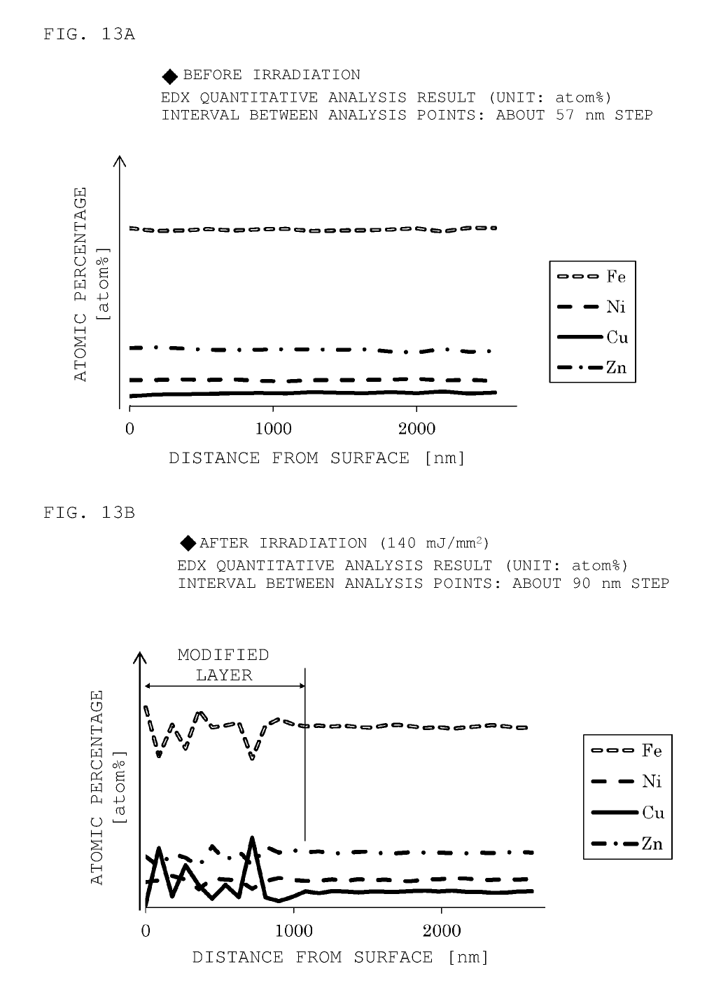

FIG. 11 shows the relationship between the thickness of the modified layer and the resistivity in Samples 1 to 6, and FIG. 12 shows the relationship between the thickness of the Cu segregated layer and the resistivity in Samples 1 to 4. The numbers in the figure indicate the respective sample numbers. The resistivity is obtained by bringing a probe into contact with the material surface, measuring the resistance value between them with an electrometer, and converting the resistance value into Ω·cm. As is apparent from FIG. 11, the thickness of the modified layer formed in Sample 4 (energy: 85 mJ/mm²) was 0.5 μm and the resistivity was 10⁵Ω·cm, whereas the thickness of the modified layer formed in the other samples (energy: 140 to 500 mJ/mm²) was 1 μm or more, and the resistivity decreased to 10²Ω·cm or less. The resistivity of the unmodified layer was 10¹²Ω·cm or more. As is apparent from FIG. 12, the thickness of the Cu segregated layer was 0.5 μm or more in Samples 1 to 3, whereas the thickness of the Cu segregated layer was about 0.3 μm in Sample 4.

As a result, as shown in FIG. 11, Ni plating could be deposited in the samples other than Sample 4. On the other hand, in Sample 4, the thickness of the modified layer was about 0.5 μm and the resistivity was 10⁵Ω·cm, and accordingly, Ni plating could not be deposited. From the above results, it can be seen that when the thickness of the modified layer is 1 μm or more, Ni plating can be formed. It is presumed that the same results can be obtained also in plating using other metal such as Cu, Sn, Au, Ag or Pd other than Ni.

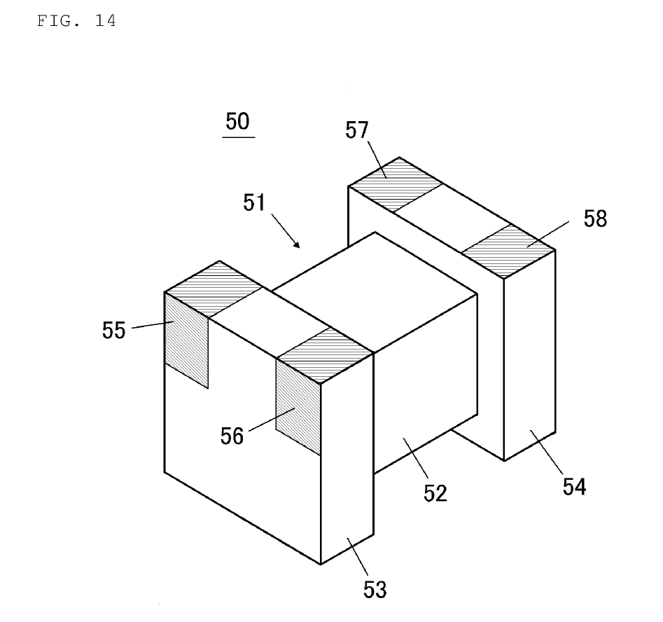

FIGS. 13A and 13B show EDX quantitative analysis results of metal elements before and after irradiating a Ni—Cu—Zn ferrite with a laser (energy: 140 mJ/mm²). The component ratios of the metal elements at a certain longitudinal section before irradiation and after irradiation are shown in FIGS. 13A and 13B, respectively. As shown in FIG. 13A, it can be seen that Fe, Ni, Cu and Zn are distributed in the thickness direction at a substantially constant ratio before laser irradiation. On the other hand, after laser irradiation, the surface is modified to a depth of about 1 μm from the surface, and the component ratio of the respective metal elements is changed as shown in FIG. 13B. Particularly, in the modified layer, the component ratio of Cu largely varies due to effect of segregation. The peak portion of Cu represents the Cu segregation portion, and each component ratio of Fe, Ni and Zn decreases at this portion. There is a region where the component ratio of Cu is low near a depth of 1 μm, and this region is a Cu non-segregation layer.

FIG. 14 shows an example of a common mode choke coil 50 of two lines (four terminals) as a second embodiment of the present disclosure. FIG. 14 shows the coil component 50 turned upside down. In this coil component 50, a winding core portion 52 is provided at the center portion of a ferrite core (ceramic body) 51, and a pair of flange parts 53 and 54 is provided at both axial ends. A plurality of wires is wound around the winding core portion 52. For example, two wires (not shown) may be wound in parallel on the winding core portion 52. Two (four in total) external electrodes 55 to 58 are respectively formed from the bottom surfaces to the outer surfaces of the flange parts 53 and 54. One ends of the two wires may be connected and fixed on the external electrodes 55 and 56 of the one end side flange portion 53, and the other ends of the wires may be connected and fixed on the external electrodes 57 and 58 of the other end side flange portion 54.

In this embodiment, similarly to FIG. 2, a modified layer (not shown) is formed from the bottom surface side to the outer surface side of the flange parts 53 and 54, and the external electrodes 55 to 58 are formed on the modified layer by plating treatment. In FIG. 14, the bottom surface sides of the flange parts 53 and 54 are formed flat, but only the sites where the external electrodes 55 to 58 are formed may be formed in a convex shape. In other words, recessed parts may be formed between the external electrodes 55 and 56, and between the external electrodes 57 and 58. Further, the external electrodes 55 to 58 are not limited to those formed along both side edges of the flange parts 53 and 54, but may be formed at sites inside the both side edges. In either case, the positions of the external electrodes 55 to 58 can be freely set depending on the formation position of the modified layer.

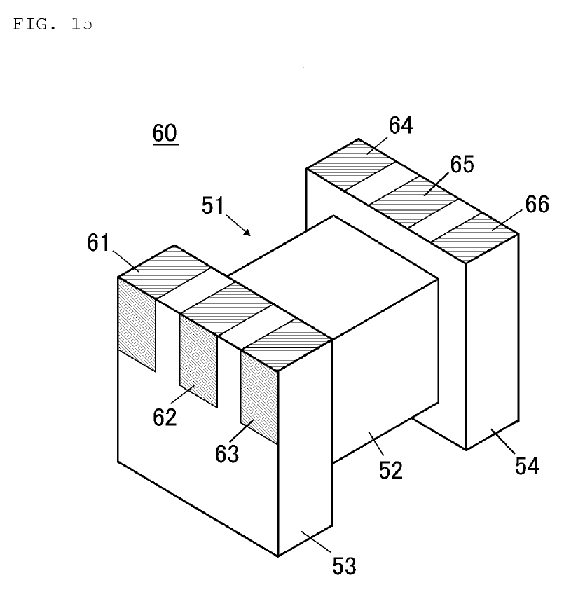

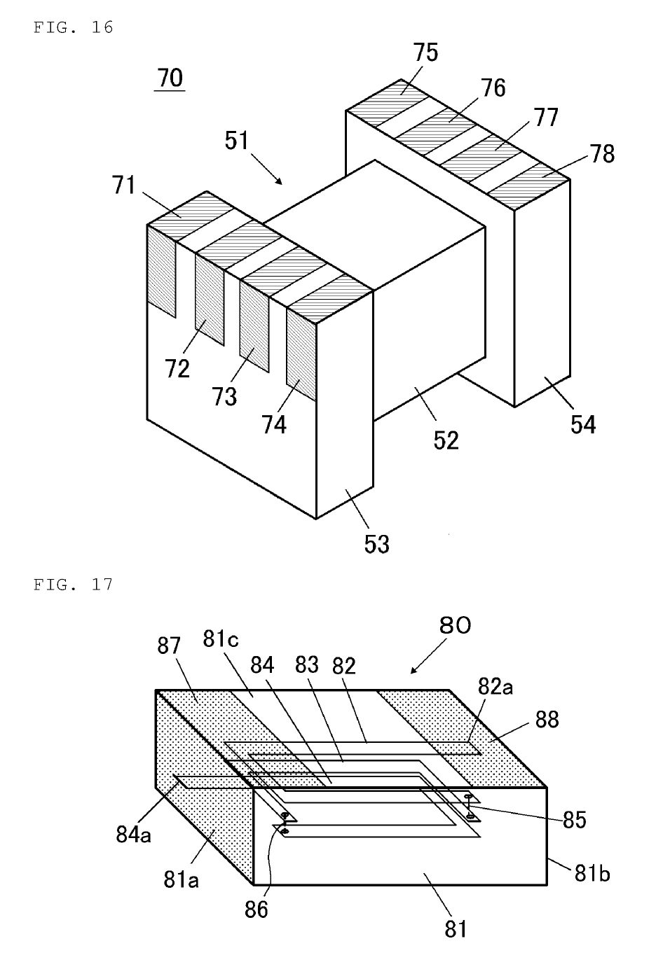

FIG. 15 shows a coil component 60 of three lines (six terminals) as a third embodiment of the present disclosure, and FIG. 16 shows an example of a coil component 70 of four lines (eight terminals) as a fourth embodiment of the present disclosure. In both figures, the coil components 60 and 70 are turned upside down. The same reference numerals are given to the parts common to FIG. 14, and redundant explanation is omitted. Three (six in total) external electrodes 61 to 66 are respectively formed by plating treatment from the bottom surfaces to the outer surfaces of the flange parts 53 and 54 in the component 60 of three lines. One ends of three wires (not shown) are connected and fixed to the external electrodes 61 to 63 of one flange portion 53, and the other ends of the wires are connected and fixed to the external electrodes 64 to 66 of the other flange portion 54. Similarly in the case of the coil component 70 of four lines, four (eight in total) external electrodes 71 to 78 are respectively formed by plating treatment from the bottom surface sides to the outer surface sides of the flange parts 53 and 54. One ends of four wires (not shown) are connected and fixed to the external electrodes 71 to 74 of the one end side flange portion 53, and the other ends of the wires are connected and fixed to the external electrodes 75 to 78 of the other end side flange portion 54. Modified layers (not shown) are formed on the lower layer sides of the external electrodes 61 to 66, 71 to 78, that is, the surface layer parts of the flange parts 53 and 54.

FIG. 17 shows an example of applying the present disclosure to a multilayer inductor 80. FIG. 17 is shown turned upside down so that the bottom surface side faces upward. In addition, the internal electrodes are also shown in a perspective view. The ceramic body 81 of the inductor 80 is obtained by stacking a plurality of insulator layers in the vertical direction and sintering the laminate. Coil conductors 82 to 84 constituting the internal electrodes are each formed on the intermediate insulator layer excluding the insulator layers at both upper and lower ends. These three coil conductors 82 to 84 are mutually connected by via conductors 85 and 86, and are formed in a spiral shape as a whole. One end (extended portion) 84a of the coil conductor 84 is exposed on one end surface 81a of the ceramic body 81, and one end (extended portion) 82a of the coil conductor 82 is exposed on the other end surface 81b of the ceramic body 81. Although the example in which the coil conductors 82 to 84 form coils for two turns is shown in this embodiment, the number of turns is arbitrary, and the shape of the coil conductor and the number of layers of the insulator layer can be arbitrarily selected.

The external electrodes 87 and 88 are each formed in an L-shaped cross section. That is, the external electrode 87 is formed in L-shape so as to cover the one end surface 81a and a portion of the bottom surface (mounting surface) 81c of the ceramic body 81, and the external electrode 88 is formed in L-shape so as to cover the other end surface 81b and the bottom surface 81c of the ceramic body 81. The external electrode 87 is connected to the extended portion 84a of the coil conductor 84, and the external electrode 88 is connected to the extended portion 82a of the coil conductor 82. These external electrodes 87 and 88 are also formed by plating treatment, and a modified layer (not shown) is formed on the lower layer side of the external electrodes 87 and 88, that is, the surface layer portion of the ceramic body 81. The plating layer constituting the external electrodes 87 and 88 is not limited to one layer, and may include a plurality of layers.

The shape of the external electrodes 87 and 88 is not limited to the L-shape. In FIG. 17, the external electrodes 87 and 88 are formed over the entire width in the width direction, but may be formed at the middle portion in the width direction. Further, the external electrodes 87 and 88 formed on the both end surfaces 81a and 81b are not necessarily formed so as to spread out in the height direction, but may be formed in a portion in the height direction. The shape of the external electrodes 87 and 88 can also be arbitrarily changed by changing the formation site of the modified layer.

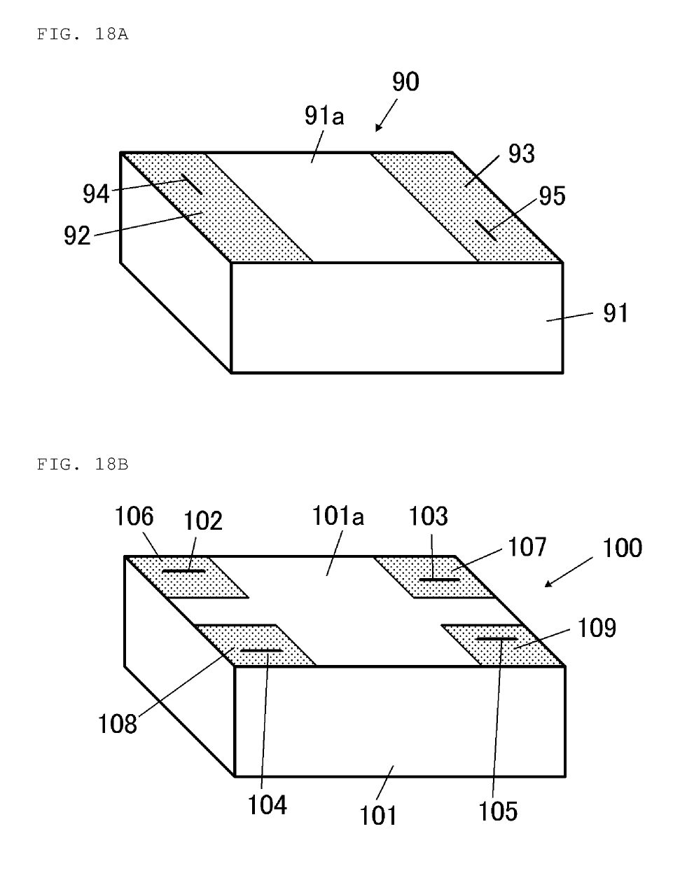

FIGS. 18A and 18B show other examples of applying the present disclosure to a multilayer inductor 90. FIG. 18A shows an electronic component 90 in which external electrodes 92 and 93 are formed at both ends of the bottom surface 91a (shown turned upside down in FIGS. 18A and 18B) of the ceramic body 91. No external electrode is formed on the other surfaces. In this case, the ends 94 and 95 of the internal electrode are not exposed on both end surfaces 91b and 91c of the ceramic body 91, but are exposed only on the bottom surface 91a. On the bottom surface 91a of the ceramic body 91, the external electrodes 92 and 93 are formed so as to be connected to the ends 94 and 95 of the internal electrodes, respectively. In the case of this inductor 90, unlike the inductor of FIG. 17, a plurality of insulator layers are stacked in the lateral direction, and the axis line of the coil conductor which serves as the internal electrode is also in the lateral direction. Modified layers (not shown) are formed on the lower layer side of the external electrodes 92 and 93, and external electrodes 92 and 93 are formed thereon by plating treatment.

FIG. 18B shows a multi-terminal electronic component 100. In this embodiment, four extended parts 102 to 105 of the internal electrode are exposed at four locations on the bottom surface 101a of the ceramic body 101, and four external electrodes 106 to 109 are formed by plating treatment so as to cover the exposed parts. No external electrode is formed on the surface other than the bottom surface. Modified layers (not shown) are formed on the lower layer side of the external electrodes 106 to 109.

In the above embodiment, an example of applying the present disclosure to the formation of the external electrode of the inductor is shown, but the present disclosure is not limited thereto. The electronic component to which the present disclosure is directed is not limited to an inductor, but any electronic component using a ceramic body in which a modified layer is formed by melting and solidification, and at least one of metal elements constituting a metal oxide is segregated in the modified layer is applicable. That is, the material of the ceramic body is not limited to ferrite.

In the above embodiment, laser irradiation is used as a method of melting and solidification of the ceramic body, but irradiation with electron beam, heating using an image furnace and the like are also applicable. In either case, since the energy of the heat source can be condensed and the ceramic body can be locally heated, the electrical characteristics of the other regions are not impaired.

In the case where a laser is used to form the modified layer, one laser may be spectrally separated to simultaneously irradiate a plurality of places with the laser. Furthermore, the focus of the laser may be shifted so that the irradiation range of the laser may be widened as compared with the case where the laser is focused.

The present disclosure is not limited to the case where all the electrodes formed on the surface layer portion of the ceramic body are composed of only the plating electrodes. That is, the present disclosure is applicable to the case where the electrodes are formed of a plurality of materials. For example, a base electrode is formed on a portion of the surface of ceramic by using a conductive paste, sputtering, vapor deposition or the like, a modified layer is formed at a site adjacent to the base electrode, and a plating electrode may be continuously formed on the modified layer and the base electrode. In addition, the application site of the modified layer can be arbitrarily selected.

What is claimed is:

1. A ceramic electronic component comprising:
a ceramic body containing a metal oxide;
a modified layer formed on a portion of a surface layer portion of the ceramic body on which the metal oxide is melted and solidified, and at least one of metal elements constituting the metal oxide is segregated in the modified layer; and
an electrode comprising a plated metal formed on the modified layer.

2. The ceramic electronic component according to claim 1, wherein the ceramic body is ferrite containing Cu, and the Cu is segregated in an upper layer portion of the modified layer.

3. The ceramic electronic component according to claim 2, wherein the modified layer has a Cu segregated layer in the upper layer portion and has an unsegregated layer in which Cu is not segregated in a lower layer portion.

4. The ceramic electronic component according to claim 2, wherein the Cu is segregated in a stripe or mesh shape.

5. The ceramic electronic component according to claim 1, wherein the ceramic body is a ferrite containing Cu, Zn, and Ni, and the Zn and Ni are present to avoid segregation of the Cu in the modified layer.

6. The ceramic electronic component according to claim 3, wherein the Cu is segregated in a stripe or mesh shape.

7. The ceramic electronic component according to claim 2, wherein the ceramic body is a ferrite containing Cu, Zn, and Ni, and the Zn and Ni are present to avoid segregation of the Cu in the modified layer.

8. The ceramic electronic component according to claim 3, wherein the ceramic body is a ferrite containing Cu, Zn, and Ni, and the Zn and Ni are present to avoid segregation of the Cu in the modified layer.

9. The ceramic electronic component according to claim 4, wherein the ceramic body is a ferrite containing Cu, Zn, and Ni, and the Zn and Ni are present to avoid segregation of the Cu in the modified layer.

10. The ceramic electronic component according to claim 1, wherein a thickness of the modified layer is at least 1 μm.

11. A ceramic electronic component comprising:
a ceramic body containing a metal oxide;
a modified layer formed on a portion of a surface layer portion of the ceramic body on which the metal oxide is melted and solidified, at least one of metal elements constituting the metal oxide is reduced in the modified layer, and plating deposition properties of the modified layer are higher than those of an unmodified layer; and
an electrode comprising a plated metal formed on the modified layer.

12. The ceramic electronic component according to claim 11, wherein a thickness of the modified layer is at least 1 μm.

13. A method for manufacturing a ceramic electronic component comprising:
preparing a ceramic body containing a metal oxide;
melting and solidifying the metal oxide on a portion of a surface layer portion of the ceramic body to form a modified layer in which at least one of metal elements constituting the metal oxide is segregated; and
forming an electrode on the modified layer by plating treatment.

14. The method for manufacturing a ceramic electronic component according to claim 13, wherein the melting and solidifying the metal oxide to form the modified layer is performed by local heating by one of laser irradiation, electron beam irradiation and an image furnace.

15. The method for manufacturing a ceramic electronic component according to claim 13, wherein the plating treatment is performed by an electroplating method.

16. The method for manufacturing a ceramic electronic component according to claim 14, wherein the plating treatment is performed by an electroplating method.

17. A method for manufacturing a ceramic electronic component comprising:
preparing a ceramic body containing a metal oxide;
melting and solidifying the metal oxide on a portion of a surface layer portion of the ceramic body to form a modified layer in which at least one of metal elements constituting the metal oxide is reduced, plating deposition properties of the modified layer being higher than those of an unmodified layer; and
forming an electrode on the modified layer by plating treatment.

18. The method for manufacturing a ceramic electronic component according to claim 17, wherein the melting and solidifying the metal oxide to form the modified layer is performed by local heating by one of laser irradiation, electron beam irradiation and an image furnace.

19. The method for manufacturing a ceramic electronic component according to claim 17, wherein the plating treatment is performed by an electroplating method.

20. The method for manufacturing a ceramic electronic component according to claim 18, wherein the plating treatment is performed by an electroplating method.
